(19) United States
(12) Patent Application Publication
(10) Pub. No.: US 2008/0256270 A1
(43) Pub. Date: Oct. 16, 2008

(54) Quality of service based preemptive routing

(76) Inventors: Robert A. Hubbs, Kelowna (CA); Sean C. Carroll, Kelowna (CA)

Correspondence Address: Antony C. Edwards, P.O. Box 26020, Westbank, BC, V4T 2G3, CA

(21) Appl. No.: 12/073,221

(22) Filed: Mar. 3, 2008

Related U.S. Application Data
(60) Provisional application No. 60/904,383, filed on Mar. 2, 2007.
(60) Provisional application No. 60/904,384, filed on Mar. 2, 2007.
(60) Provisional application No. 60/904,386, filed on Mar. 2, 2007.

(51) Int. Cl. G06F 3/00

(52) U.S. Cl. 710/38

(57) ABSTRACT

Disclosed is a method of controlling communication between a plurality of devices having a plurality of routing paths between the plurality of devices. The method comprises measuring quality of communication between each of the plurality of devices and recording communication values representing the quality of communication with an associated repeating time value. The method further comprises selecting a current time value corresponding to a desired time period according to a selection criteria and selecting a routing path having an optimized communication value corresponding to the current time value. The communication values may be determined by utilizing a plurality of quality of service indicators including quality of service amplitude, quality of service signal quality and quality of service reported. The communication values may be used to distribute functions from the master device to a designated slave device in response to a triggering event.

### CROSS REFERENCE TO RELATED APPLICATION

This application claims priority from U.S. Provisional Patent Application No. 60/904,383 filed Mar. 2, 2007 entitled Service Quality Based Optimize Preemptive Routing, U.S. Provisional Patent Application No. 60/904,384 filed Mar. 2, 2007 entitled Adaptive Distributed Network Host Functionality, and U.S. Provisional Patent Application No. 60/904,386 filed Mar. 2, 2007 entitled Multi Mode Dynamic and Cyclical PLC Quality of Service Indicators.

### BACKGROUND OF THE INVENTION

1. Field of Invention

The present invention relates to routing, particularly in a distributed network. More particularly, the present invention relates to utilizing quality of service indicators to preemptively determine and utilize alternate routing paths.

2. Description of Related Art

Networks incorporating distributed or remote nodes, components or devices have traditionally posed several problems of reliability. Due to the remote location or distributed nature of these types of networks, they have been prone to interrupted or sporadic communication and a greater likelihood of missed messages or data. Additionally, the need for the remote or distributed devices to be in continuous or intermittent communication with a central or master unit as well as with each other may create a large amount of network traffic that may further obscure critical communication between two specific devices.

Power line and radio frequency communication, in particular have been found to be prone to limitations affecting previous strategies for monitoring and controlling remote devices. Both are known to have significant problems with higher bandwidth due to the interference of noise and loss of signal.

Solutions to these problems have traditionally been addressed in several ways. Previously, the message or signal may include error detection elements to ensure that a given message is received and to request that it be resent in the event of an error. Such additions to the message, however further increase the size of the message. Additionally, the resent message may also further increase the total traffic on the network.

Methods of routing have enabled such distributed networks to select paths between specific devices to ensure that a message is received. Such routing methods, however are often reactive to a problem being detected at any given point such as when used in network discovery. Such routing methods are also known to increase the total volume of traffic on a network due to the discovery process of interrogating each possible route to select the optimal route for that given period. The time delays associated with methods of network discover are also undesirable.

### SUMMARY OF THE INVENTION

According to a first embodiment of the present invention there is disclosed a method of controlling communication between a plurality of devices having a plurality of routing paths between said plurality of devices. The method comprises measuring quality of communication between each of the plurality of devices and recording communication values representing the quality of communication with an associated repeating time value. The method further comprises selecting a current time value corresponding to a desired time period according to a selection criteria and selecting a routing path having an optimized communication value corresponding to the current time value.

The selection criteria may comprise combining successive communication values corresponding to the same repeating time value. The combining may comprise utilizing a simplified smoothing function.

The communication values may be recorded intermittently. The communication values may be recorded continuously. The communication values may be recorded in a designated distributed device. The method may further comprising requesting the communication values from the designated distributed device.

The repeating time values may comprise a plurality of cyclical time segments ordered in a continuous repeating loop. The repeating time value may repeat once every day. The repeating time value may repeat once every week.

Measuring communication may comprise measuring a communication signal between a first device and each of the plurality of devices and wherein the communication values are recorded by the first device. The communication values may be determined by utilizing a plurality of quality of service indicators. The quality of service indicators may be selected from the group consisting of quality of service amplitude, quality of service signal quality and quality of service reported.

Selecting a routing path may comprise selecting at least one alternate route and selecting a best route of the at least one alternate routes having a highest combined quality of service amplitude indicator and quality of service signal quality indicator. The at least one alternate routes may be selected to have the highest quality of service reported indicator from all of the routing paths. Three of the at least two alternate routes may be selected. For each of the at least two alternate routes, the quality of service amplitude indictor and the quality of service signal quality indicator are combined by a weighted value.

The quality of service amplitude may be determined by comparing the communication signal amplitude to a known amplitude condition. The known amplitude condition may comprise a theoretical ideal amplitude. The known amplitude condition may comprise a previously best recorded amplitude.

The quality of service signal quality may be determined by comparing the communication signal to a known signal quality condition. The known signal quality condition may comprise a theoretical ideal signal quality. The known signal quality condition may comprise a previously best recorded signal quality.

The quality of service reported may comprise recording a reported list representing a rate of occurrence of communication between the plurality of devices. The reported list represents a rate of occurrence at which each of the plurality of devices is not in communication with the first device. The plurality of devices may form a part of a network having a master device and a plurality of slave devices.

The method may further comprise using the communication values to distribute functions from the master device to a designated slave device. The functions may be distributed from the master device to the designated slave device in response to a triggering event. The triggering event may be a predetermined time occurrence. The designated slave device may be selected prior to the triggering event.

The designated slave device may be selected by weighting the quality of service amplitude, the quality of service signal quality and the quality of service reported. The quality of service reported may be assigned a greater weight than the quality of service amplitude and the quality of service signal quality. The quality of service amplitude and the quality of service signal quality may be assigned a greater weight than the quality of service reported.

The method may further comprise utilizing the communication values to record an ordered list of the designated slave devices for each corresponding repeating time value.

### BRIEF DESCRIPTION OF THE DRAWINGS

In drawings which illustrate embodiments of the invention wherein similar characters of reference denote corresponding parts in each view,

FIG. 1 is a schematic representation of a distributed network having a plurality of distributed nodes or devices.

FIG. 2 is a schematic representation of the distributed network of FIG. 1 having interrupted connections between some of the devices.

FIG. 3 is a flow chart illustrating a method for measuring, recording and predicting the quality of network routes.

FIG. 4 is a flow chart illustrating a method of measuring and recording the quality of service signal quality (QOSS) for use in the method of FIG. 3.

FIG. 5 is a flow chart illustrating a method of measuring and recording the quality of service amplitude (QOSA) for use in the method of FIG. 3.

FIG. 6 is a flow chart illustrating a method of measuring and recording the quality of service reported (QOSR) for use in the method of FIG. 3.

FIG. 7 is a flow chart illustrating a method of measuring and recording a combined quality of service signal quality (QOSS) and quality of service amplitude (QOSA) value for use in the method of FIG. 3.

FIG. 8 is a flow chart illustrating a method for selecting routes utilizing quality of service indicators to predict the optimized route for a given time period.

FIG. 9 is a graphical illustration of time blocks for use in determining a smoothed value for one of the quality of service indicators of FIGS. 3 through 8.

FIG. 10 is a schematic representation of the distributed network of FIG. 1 having a cluster defining a sub-set of the whole distributed network serviced by a distributed network host.

FIG. 11 is a flow chart illustrating a method for identifying and assigning a cluster as a sub-set of the network of FIG. 1.

FIG. 12 is a flow chart illustrating a method for identifying and assigning a distributed network host of the network of FIG. 1.

FIG. 13 is a flow chart illustrating a method of transferring control to a distributed network host in the network of FIG. 1.

### DETAILED DESCRIPTION

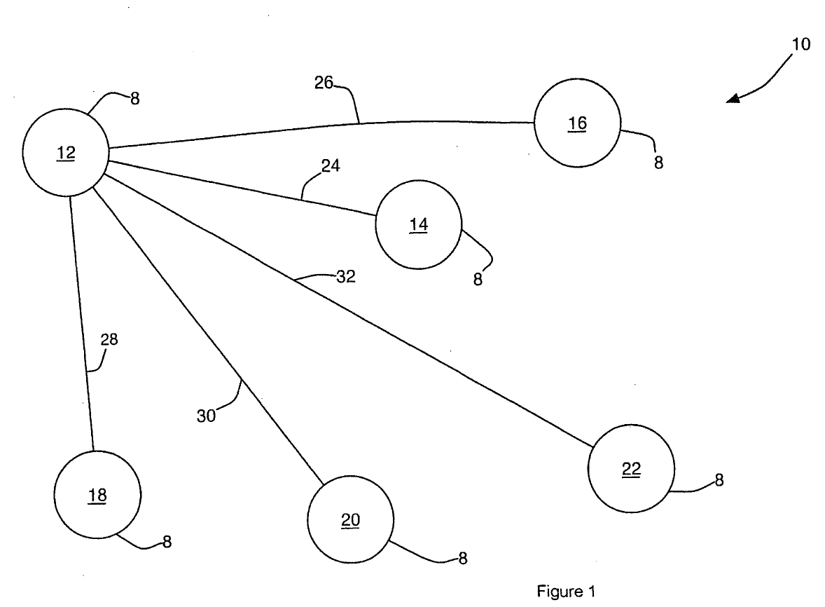

Referring to FIG. 1, a distributed network is shown generally at 10 having a plurality of distributed devices 8 and a master device 12. As illustrated, the distributed network 10 may include first, second, third, fourth and fifth distal devices, 14, 16, 18, 20 and 22, respectively. The distributed devices 8 may include any number of remote devices, such as, by way of non-limiting example process control devices, sensing modules or data relays. Although only five distributed devices 8 and a master device 12 are illustrated, it will be appreciated that more than this number of distributed devices 8 may be utilized in a distributed network as well.

The first, second, third, fourth and fifth distal devices, 14, 16, 18, 20 and 22, are in communication with the master device by associated communication links 24, 26, 28, 30 and 32, respectively. Although only communication links between the first, second, third, fourth and fifth distal devices, 14, 16, 18, 20 and 22 and the master device 12 are illustrated, it will be appreciated that there communication links between each of the first, second, third, fourth and fifth distal devices, 14, 16, 18, 20 and 22 will also typically be present in such a network 10. However, for the sake of clarity these communication links have not been shown in FIG. 1. It will be appreciated that the communication links may comprise, dedicated network links, carrier signals such as, by way of non-limiting example, power-line communication links, radio frequency transmissions or any other type of know method of data communication.

In a network 10 for use with the present invention, the locations, either physical or virtual network locations and identities of the distributed devices 8 will be known. Accordingly, it will be possible to predict the location of a particular device with reasonable certainty based upon the historical location of that device. Similarly, by knowing the location of a device, the present method utilizes data collected regarding historical communication patterns with throughout the network 10 to predict which network paths or links will have the best continuity with each other for any future time period.

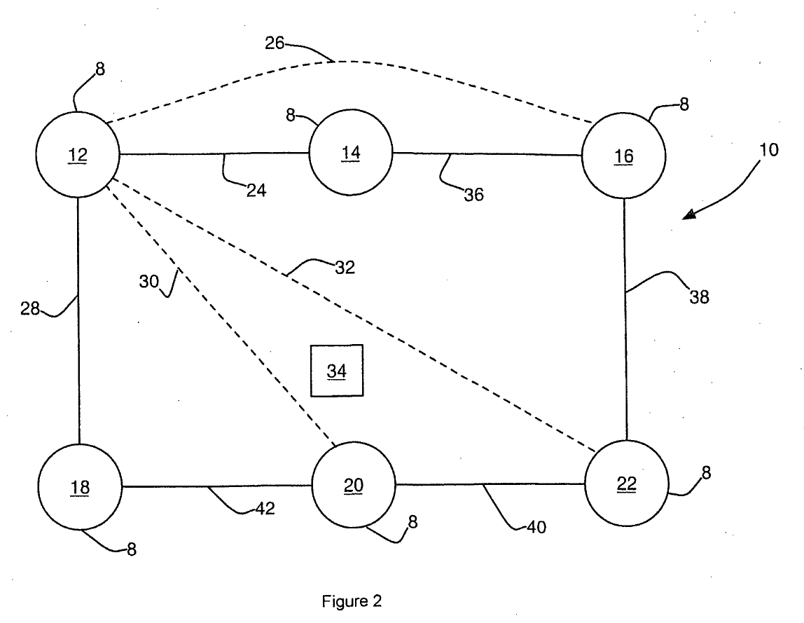

Referring to FIG. 2, the network of FIG. 1 is illustrated with a noise source 34 shown. The nose source 34 may be of a known type which may be specific to the data transmission medium being used. By way of non-limiting example, halogen lights, welders and microwave ovens, electric heater or electric motors and other types of are known to cause significant interference with power line communications. As illustrated in FIG. 2, the noise source interrupts communication links 26, 30 and 32. Accordingly, the data transmission from the master device 12 to the second, fourth and fifth distal devices 16, 20 and 22 may be interrupted if the network is utilizing only the primary communication links previously established.

The network 10 may be adapted to establish communication links 36, 38, 40 and 42, respectively so as to re-establish communication with the second, fourth and fifth distal devices 16, 20 and 22. In particular, the second distal device 16 may now communicate with the master device 12 through communication links 24 and 36 as routed by the first distal device 14. The fourth distal device 20 may now communicate with the master device 12 through communication links 28 and 42 as routed through the third distal device 18. The fifth distal device 22 may now communicate with the master device 12 through communication links 28, 42 and 40 as routed by the third and fourth distal devices 18 and 20.

Methods and systems for providing routing functions as set out above are known in many fields. However, these known methods of routing rely on discovering what possible new connection links are available after an interruption such as the inclusion of noise source 34 has occurred. In many cases however, the occurrence of some or all of the noise sources is on a regular schedule. For example, it may be known that some noise sources such as a halogen light bulb may be on fairly regularly between the hours of 5:00 AM and 7:00 AM every day. It will therefore be known that communication links adversely affected by this halogen light bulb will regularly be poor during these times as well. The method and apparatus of the present invention utilizes this regular schedule to predict specific time periods in which specific routing paths will have reduced connectivity.

In particular, the method described in greater detail below overcomes loss of communication between nodes or distributed devices 8 with the master device 12 by creating or recording a backup list of alternate communications routes before they are needed in response to the introduction of a noise source 34. These alternate communications routes are built pre-emptively by measuring a quality of service indicator (QOSI) representing the strength of each of the communications links during each period of a repeating cycle. For example, the system may measure the QOSI for each of the communications links in one hour increments throughout the period of one day. Each of these QOSI measures would then be stored and grouped according to it's corresponding time period. Thus according to the present non-limiting example, each measure of a particular path during the hour between 2:00 PM and 3:00 PM would be stored in such a way as to enable the system to predict, based upon historical measures, the strength of this same path at the next occurrence of the hour between 2:00 PM and 3:00 PM. It will be appreciated therefore, that the recording of other paths in the network 10 will permit the system to determine which alternate routes will be most effective during this time as well as to optionally reroute traffic through one of these alternate routes prior to the interruption of the communication.

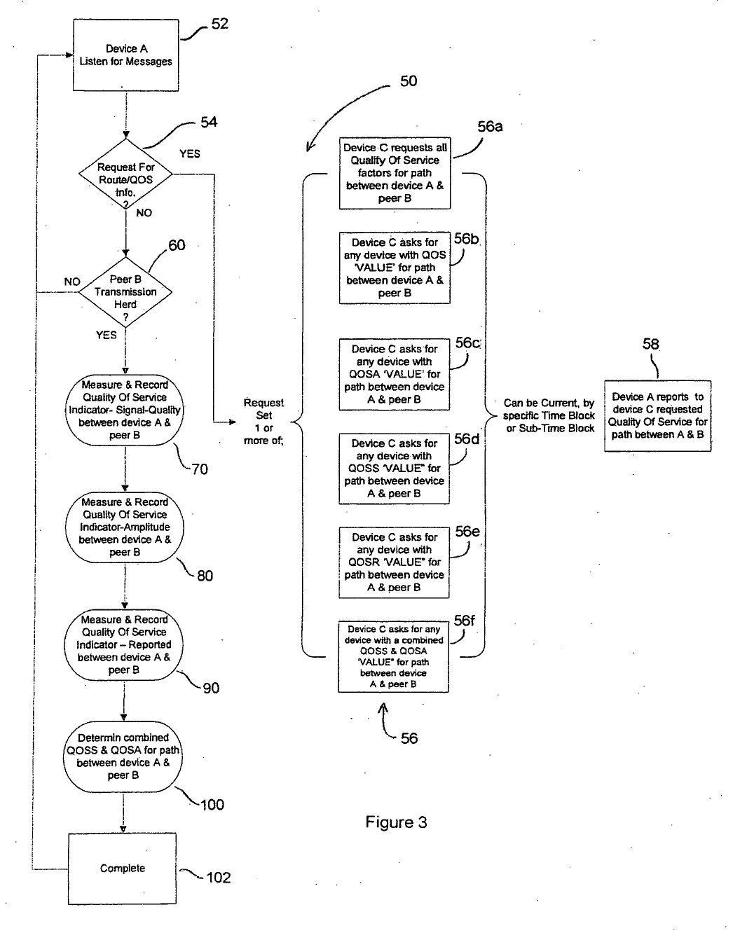

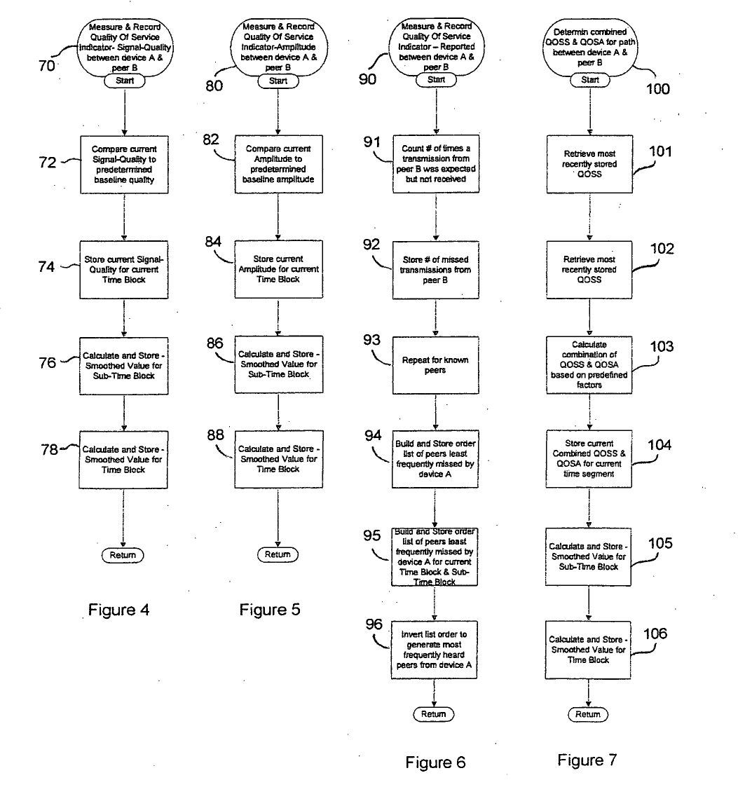

Turning now to FIGS. 3 and 4, a process 50 for measuring, recording and predicting the quality of network routes is illustrated. It will be appreciated that the current process 50 could be performed by any one of the distributed devices. In addition, the current process could be shared between a group of devices such that each of the devices performs only a portion of the process 50. In the present example, the process 50 is illustrated as being performed in device A which is in communication with devices B and C. As illustrated in FIG. 3, the process begins with a first device (herein designated as device A) listening for a messages at step 52.

Upon receipt of a message at step 54, device A checks to determine if the message is a request for route information. If the message is a request for route or quality of service information, device A checks which set of data is being requested by device C in step 56 and sends the requested information to device C in step 58. The data being requested in step 56 may include, but is not limited to all quality of service factors for the path between device A and device B or any device in communication with device A having a quality of service indicator higher than a set value on a path between devices A and B. As further discussed below, the quality of service indicator may be comprises of one or more of several quality of service indicators including the quality of service amplitude (QOSA), quality of service signal quality (QOSS) or quality of service reported (QOSR). Quality of service reported is defined herein as the count of the number of time times a transmission from a device was expected but not received wherein higher values mean more missed messages and thus a lesser quality of service.

In particular, requests by device C may request of device A for all quality of service values equal to a specified value in step 56b. These may be for any value and can be for the current time period or for any other recorded period. These values may also be used to perform a binary sort. Device C may also ask for any device with a path quality of service value equal to a specified value to device B in steps 56c through 56f. Accordingly, any device with a path to device B with that specified value will report only YES or NO. It will be appreciated that device C can make multiple requests to determine the best quality to a given device. Device C may also make multiple requests to determine specific quality to multiple devices. It will be appreciated that by asking a device if it can hear device B at a specified value and for a specified time period, the shortest possible message is transmitted between device A and device C to fill this request. Although device C may request all data from device A pertaining to the path to device B, however this is typically done during off peak times for efficiency reasons.

If the message is not a request for data from device C, device A compares the message to determine if it was a transmission from device B in step 60. If the transmission was not from device B, device A returns to listening for a message. If the transmission was from device B, device A then proceeds to measure and record the quality of service signal quality (QOSS), the quality of service amplitude (QOSA) and the quality of service reported (QOSR) in steps 70, 80 and 90, respectively and further described below with reference to FIGS. 4, 5 and 6. Device A then determines a combined QOSS and QOSA value for that path between devices A and B in step 100 as further discussed below with reference to FIG. 7.

Turning now to FIG. 4, a subroutine process for measuring and recording the QOSS 70 is illustrated. It will be appreciated that any of the processes illustrated in FIGS. 4, 5, 6 and 7 may be performed by any of the distributed devices 8. The QOSS subroutine process 70 begins by comparing the current received signal quality to a predetermined signal quality in step 72. This may be performed by comparing the measured signal to a known signal or a baseline pair by known methods. By way of non-limiting example, the measured signal may be compared against a theoretical signal representing a best case fit under ideal conditions for the path. The measured signal may also be compared against the best previously recorded signal quality. Methods of conducting such comparisons are commonly known to those skilled in the art.

By way of non-limiting example, a single bit may be used to determine both QOSA and QOSS for a single bit by both frequency shift keying and binary phase shift keying. The worst case from a message is utilized to get a message quality indicator. For example, the worse case QOSS bit in a message may be used to represent QOSS and the worst case QOSA bit in a message may be used to represent QOSA. For the present example, the bit of the message used need not be the same bit. In the present example, these give values of 0 though 15 that is they occupy 4 bits. This message would be sent out in the form of [QOSS, QOSA]. That is if QOSS is 1001 (nine) and QOSA is 0011 (three) what is sent is 10010011 (one hundred and forty seven). Note that this is already QOSS*16+QOSA and can be used directly. In this example, the combined [QOSS, QOSA] is utilized by picking the biggest value of it to route through.

The receiving device may be adapted to keep the last result as well as keep a smoothed value result from the past few results without using a lot of memory. For the case where few samples are going to be received a moving average could be utilized instead. Note that this, in combination with QOSR, gives a short term, an intermediate term, and a long term indication of quality.

By way of non-limiting example, a simple and effective smoothing function can be performed as follows. Starting with zero add a sample then divide the result by four and store this value. When a new sample comes in multiply the stored value by 3, add the new sample then divide the result by 4, and so on. In general this equation takes the form:

New Stored Value=((n−1)*Old Stored Value+Sample)/n

It is advantageous to have ln(n)/ln(2) be an integer so that the division can be performed by shifting in the case where the samples are positive in value. Larger values of n result in greater smoothing.

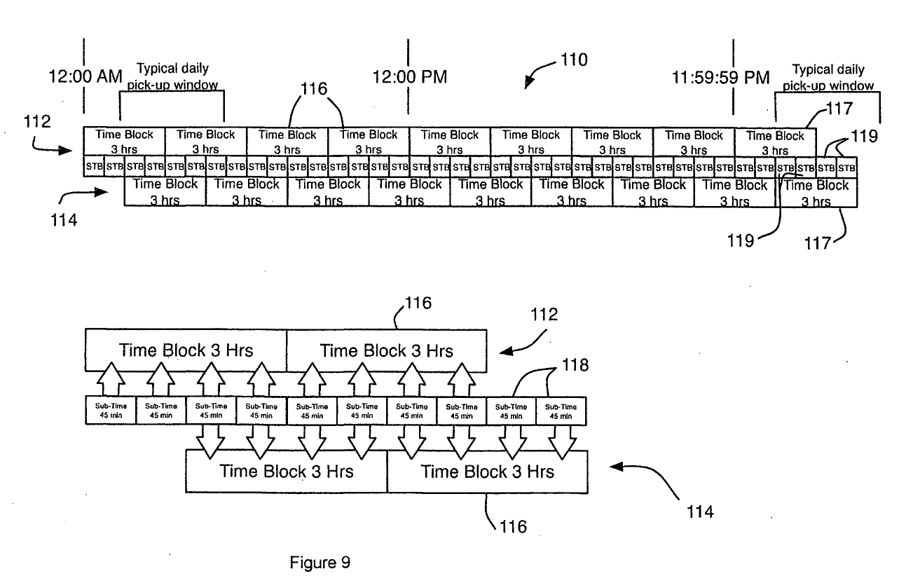

A value representing the QOSS is then assigned to this measured signal and this value stored for the current time block in step 74. In step 76, the process then calculates and stores a smoothed value for the sub-time block in which this value represents as further discussed in reference to FIG. 9. The process then calculates and stores a smoothed value for the time block in which this value represents as further discussed in reference to FIG. 9 below at step 78.

Turning now to FIG. 5, a subroutine process for measuring and recording the QOSA 80 is illustrated. The QOSA subroutine process 80 begins by comparing the current received signal amplitude to a predetermined amplitude in step 82. This may be performed by comparing the measured signal to a known signal or a baseline pair by known methods. By way of non-limiting example, the measured signal may be compared against a theoretical amplitude representing ideal conditions for the path. The measured signal may also be compared against the best previously recorded amplitude. Methods of conducting such comparisons are commonly known to those skilled in the art.

A value representing the QOSA is then assigned to this measured signal and this value stored for the current time block in step 84. In step 86, the process then calculates and stores a smoothed value for the sub-time block in which this value represents as further discussed in reference to FIG. 9. The process then calculates and stores a smoothed value for the time block in which this value represents as further discussed in reference to FIG. 9 below at step 88.

Turning now to FIG. 6, a subroutine process for measuring and recording the QOSR 90 is illustrated. Quality of service reported is defined herein as the count of the number of time times a transmission from a device was expected but not received wherein higher values mean more missed messages and thus a lesser quality of service. The QOSR subroutine process 90 begins by counting the number of times a transmission from device B was expected but not received at device A in step 91. A device specific value representing the quantity of missed communications from device B is then stored in device A at step 92. Steps 91 and 92 are then repeated for all known devices in communication with device A at step 93. All of the device specific values from steps 91 through 93 above are then stored in an ordered list at step 94. This list may be in order of from the most frequently heard devices or from the least frequently heard devices. At step 95, the subroutine process 90 builds a list of distributed devices 8 least frequently missed for a given time period as further discussed in reference to FIG. 9 below. The QOSR subroutine process at step 96, then inverts the list created in step 95 to provide a list of the most frequently heard by device A.

Turning now to FIG. 7, a combined subroutine process for measuring a combined QOSS and QOSA 100 is illustrated. The combined subroutine process begins by retrieving the most frequently stored QOSS and the most frequently stored QOSA in steps 101 and 102, respectively. A combination of the QOSS and QOSA is then calculated for each device. These factors could, for example be a weighting function between the QOSS and QOSA so as to make the condition of one of these values dominant over the other. As illustrated in step 103, the QOSS and QOSA values may be combined with a weighting of 1:1 or may optionally being combined with a weighting of 16:1 (for example (QOSS×16)+QOSA). In step 105, the distributed device 8 then calculates and stores a smoothed average for the sub-time block in which this value represents as further discussed in reference to FIG. 9. The process then calculates and stores a smoothed value for the time block in which this value represents as further discussed in reference to FIG. 9 below at step 106.

Thus, by utilizing the above method, when routing is required, paths with the highest predicted path integrity for that historical time cycle are used first thus avoiding the time cost associated with building new routes non-deterministically and yet not being subject to deterministic routing failure. Additionally, if direct communication between master and the slave is lost then the master device 12 will request routing assistance from a slave device based on a routing table contained in the master device and/or appropriate distributed devices. The slave routing is built by analysis of connection data including the QOSI and the various quality of service factors (QOSA, QOSS and QOSR). Furthermore, the master device can request specific slave devices to transmit a routing status and route details including QOSI and QOS factor detail for themselves or for other slave devices. The master processes the data to build the preemptive route. It will be appreciated that the slave will record the highest QOSI value as a preferred routing point and provide this preferred rout to the master. It will be further appreciated, that by this method the master device builds a time correlated optimized preemptive route map to be used whenever communications quality is compromised or other times at the master's discretion.

It will also be appreciated that different quality of service indicators will provide different measures of the network quality and will therefore be used at different times. For example, the QOSR provides the longest time period view of “optimized routes” and is therefore useful for determining long-term routing solutions such as for responding to catastrophic failures, for example. Also since most or all of the information needed is present in the master based on prior collection of time block data, decisions and selections are made very quickly and do not delay route selection. Even when all information is not present, the selection is still highly likely to find a good or very good route based on prior collection of time block data. Additionally, even during these cases, only minimal data must be transmitted in real time to determine the optimized route if the previously collected data is not sufficient.

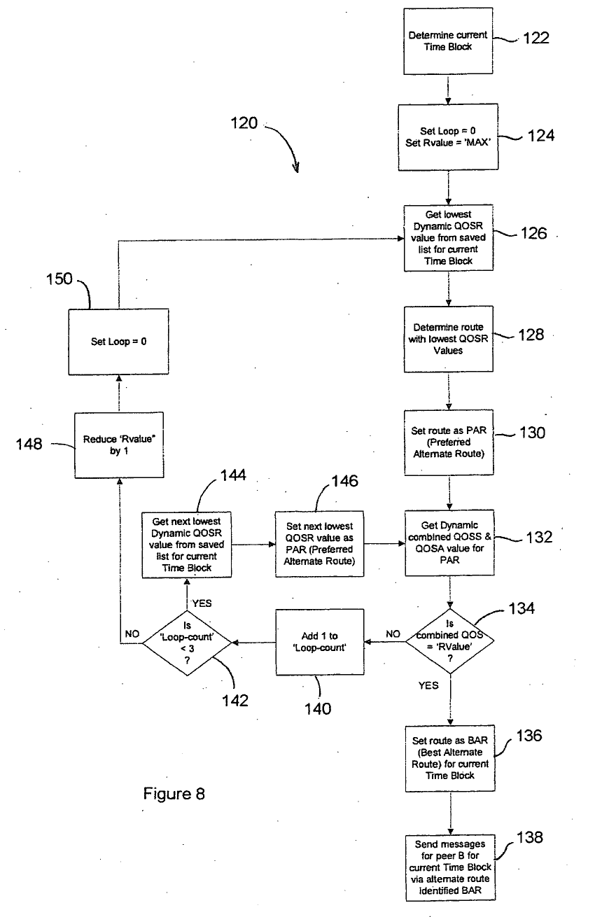

Referring now to FIG. 8, a preemptive route selection process 120 is illustrated. In the current non-limiting example, the preemptive route selection process 120 is performed in a device labeled device A which is desired to be in communication with device B by one of a group of possible routes. This is done by trying the three best QOSR routes between device A and B which have a high QOSS QOSA values. This may be determined by preference to the values of the QOSR, QOSS and QOSA indexes, in this order. It will be appreciated that in the current embodiment of the process, looping functions are introduced to ensure that the best reported routes as determined by the QOSR do not dominate when short-term or transient activities dictate a different preferred route. It will be appreciated that other orders may also be useful for other network situations. It is expected that prior to the preemptive route selection process 120 being performed, that the processes illustrated in FIGS. 3 through 7 and described above will already have been performed. It will be appreciated that the method for selecting the route having a best combined QOSA and QOSS value from the routes having the best QOSR may also be accomplished by other processes and methods. The preemptive route selection process 120 begins by determining the current time block in step 122. This may be provided by an external or internal clock by known methods. The process then sets a loop count variable equal to 0 and an Rvalue equal to ‘MAX’ in step 124. The Rvalue is a value representing the desired combined QOSS and QOSA value for the route to be selected. As more fully described below, the Rvalue is first set to an optimum value and progressively reduced until one route is found having that immediate Rvalue. For the sake of clarity, the Rvalue during any given iteration of the present process will be referred to as the current Rvalue. The loop variable is a variable which determines how the number of routes having the best QOSR value are compared against the desired RValue.

At step 126, the preemptive route selection process 120 retrieves the lowest dynamic QOSR value from a saved list corresponding to the current time block defined in step 122. A route corresponding to the lowest dynamic QOSR value is then retrieved in step 128. This route is set as the Preferred Alternate Route in step 130 and a combined QOSS and QOSA value obtained for this route in step 132. The combined QOSS and QOSA value is compared against the Rvalue in step 134. If the combined QOSS and QOSA value is equal to the Rvalue the process 120 proceeds to set this route as the best alternative route for the current time block in step 136. At step 138, process A sends a message to device B by the route defined as the best alternative route in step 136 above.

If the combined QOSS and QOSA value is not equal to the Rvalue in step 134, device A adds a count of 1 to the loop count at step 140 and then compares the loop count to a threshold in step 142. As illustrated in FIG. 8, the threshold is set to 3 whereby the threshold defines how many of the routes are compared against the current Rvalue. If the loop count is less than the threshold as determined by step 142, the preemptive route selection process 120 retrieves a next lowest dynamic QOSR value from the saved list corresponding to the current time block defined in step 144. A route corresponding to this next lowest dynamic QOSR value is then retrieved in step and set to the preferred alternate route in step 146. Steps 132, 134, 140 and 142 as described above are then repeated until the loop count is equal to the threshold.

It will be appreciated that although for the current non-limiting example illustrated in FIG. 8, the loop count is set to 3, that the loop count could be set to another number such that any number of possible routes are compared against the desired current Rvalue. Accordingly, as many of the possible routes as possible may be assessed to determine if one of these routes has the desired QOSR index. It will be appreciated that although it may be possible to assess all possible routes for the desired QOSR index, some of such routes may be undesirable due to poor QOSS and/or QOSA indices.

If the loop count is not less than the threshold as determined by step 142, the preemptive route selection process 120 reduces the Rvalue by a value of 1 in step 14 and resets the loop count to 0 in step 150. The process then returns to step 126 as described above. It will be appreciated that the preemptive route selection process 120 will continue to repeat this process until a route having a combined QOSS and QOSA value equal to the current Rvalue.

Turning now to FIG. 9, the time periods may have pre-determined lengths and positions in a cycle 110. By way of non-limiting example, the time periods may be selected to extend for a 3 hour period commencing at 12:00 AM. It will be appreciated that for cycles 110 that do not follow the 24 hour clock, the time period may begin at any point desired within that cycle, such as, for example, at 11:00 PM on a Monday.

A non-limiting example of the time periods is demonstrated in FIG. 9. As illustrated in FIG. 9, the cycle 110 comprises a plurality of time blocks 116 arranged in sequential order to each other. As illustrated in FIG. 9, the cycle may include two parallel sequential orders shown as first and second rows 112 and 114 in FIG. 9. The time blocks 116 of the first rows 112 and 114 may be offset from each other so as to provide two alternate time blocks 116 for use in determining the length of time an alternate route or network control may be necessary to avoid an interference source 34. Additionally, each of the time blocks 116 may be comprised of sub blocks 118. As illustrated in FIG. 9, each time block 116 comprises 4 sub-time blocks 118 although it will be appreciated that other numbers and lengths of time blocks 116 and sub-time blocks 118 may be used as well.

For each of the time blocks 116 or sub-time blocks 118, the receiving and calculating device stores a value based on a simple smoothing function for QOSS, QOSA, QOSR and a combined QOSS and QOSA index. These values may be collected daily or at another time by the master device 12 during periods of low network traffic. A simple smoothing function structure may be similar to a low-pass filter. By way of non-limiting example, a simple and effective smoothing function can be performed as follows. Starting with zero add a sample then divide the result by four and store this value. When a new sample comes in multiply the stored value by 3, add the new sample then divide the result by 4, and so on. In general this equation takes the form:

New Stored Value=((n−1)*Old Stored Value+Sample)/n

It is advantageous to have ln(n)/ln(2) be an integer so that the division can be performed by shifting in the case where the samples are positive in value. Larger values of n result in greater smoothing.

In the present embodiment, data to be stored is run through the smoothing function for each sub-time block 118. Its purpose is to remove short-term fluctuations and leave only the long term trends for a given time period. This also avoids the flaws of an average which artificially moves towards the middle of the numerical range rather then storing the trend. The time blocks 116 and sub-time block 118 are interleaved to produce a continuous and running history of the various quality of service factors and values being stored. So that the trend in any period can be measured and compared at two different time windows with overlapping periods at the higher level.

Each distributed device 8 stores the required data for each time block 116 and for each sub-time block 118 daily plus a buffer. By way of non-limiting example as illustrated in FIG. 9, this would result in 16 time-block data points with the addition of 2 overlap buffer time blocks 117 to allow for schedule variation in when the buffers are overwritten which are collected each daily cycle. In the exemplary embodiment illustrated in FIG. 9, this would also result in 34 sub-time block 118 data points with the addition of 4 overlap buffer sub-time blocks 119 to allow for schedule variation in when the buffers are overwritten. Accordingly this would result in a total of 56 data points to be stored at the device were 48 of those data points would be considered significant.

It will be appreciated by someone skilled in the art that the number of data points could be decreased or eliminated for the time blocks 116 without decreasing the usefulness of the current method. Furthermore is may be seen that the use of separate time block 116 values is for the convenience of the devices making use of this data and for efficient of communication in the event that the data points are requested during peak traffic times. Other timing and ordering schemes may include both shorter and longer time periods and more or less data points.

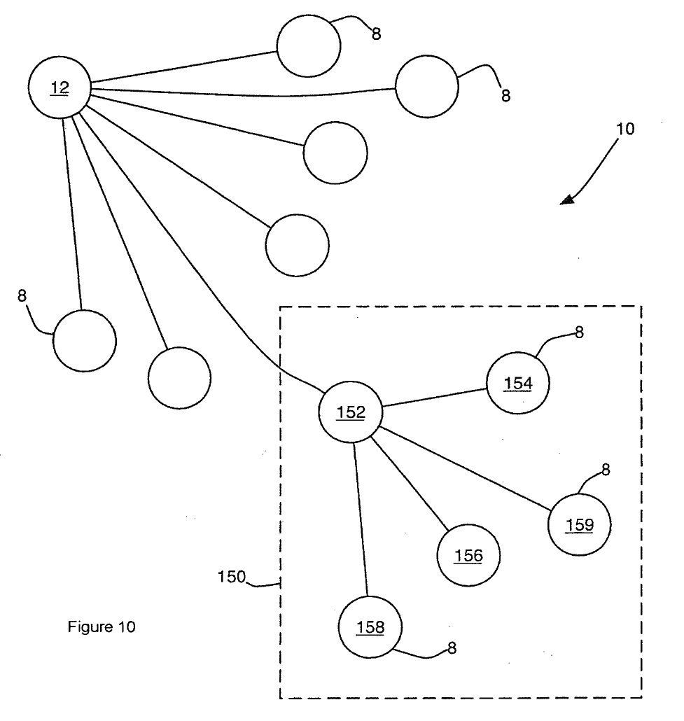

The above described methods may optionally be utilized to adapt a network by distributing some functions of the master device 12 to one or more of the distributed devices 8. With reference to FIG. 10, this may be done, for example, by identifying a cluster generally indicated at 150 forming a sub-set of the distributed devices 8 of the network 10. The master device 12 may then determine which of the devices 8 of the cluster 150 is to be designated to serve the cluster and with what services and transferring control to and from the cluster. This designated device is then renamed as the distributed network host 152 for cluster 150 and the determined serves and control, previously provided by the master device 12 are transferred to this distributed network host 152. As illustrated in FIG. 10, the cluster 150 also include cluster slave devices 154, 156, 158 and 159.

The distributed network host 152 can provide a wide range of functions to the cluster 150 including all aspects of routing, master routing table, QOSI table and route builder request. The distributed network host 152 may also perform consolidation or assign consolidating function, perform localized system startup, rule based supervisory monitoring as well as various application specific functions.

The distributed network host 152 may also listen to all communication by the master device 12 and other distributed network host devices to ensure continuity of communication. In the event of a loss of communication between any one distributed network host and the master device 12, other distributed network host devices will attempt route and consolidate communication for the distributed network host whose communication is unable to get through. In the event of a distributed network host failure other distributed network hosts will search for and designate one of the distributed devices as a new distributed network host or assume the role of the distributed network host for that sub-set of the network 10. The structure of the cluster and the arrangement of the distributed network hosts is determined through the use of the methods of predicting network continuity as described above.

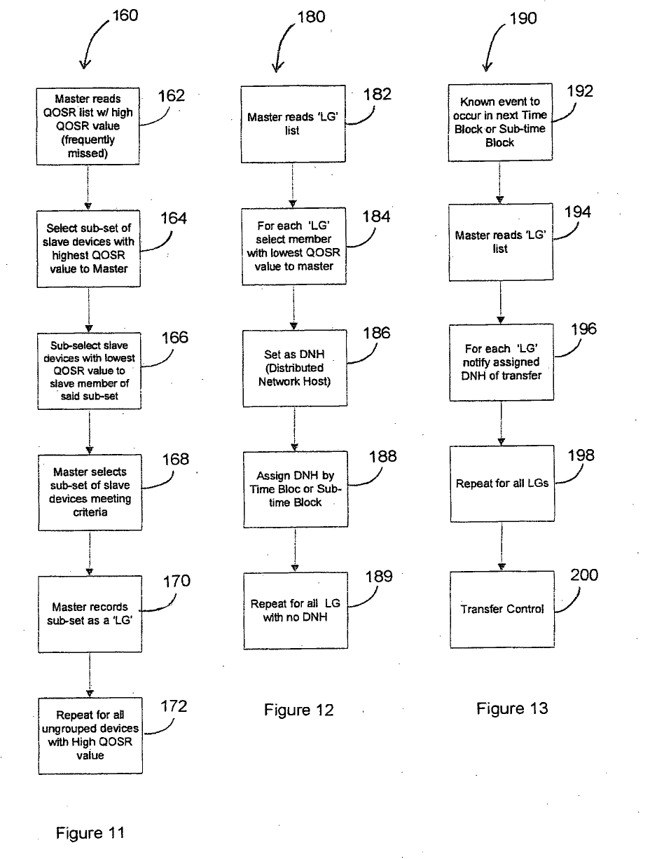

As illustrated in FIG. 11, a method for identifying, selecting and assigning a cluster 150 of distributed devices 8 to be serviced by a distributed network host is illustrated generally at 160 and referenced herein as the identifying method.

The cluster 150 may be determined by selecting a sub-set of the entire network 10 with a number of distributed devices 8 where some of the distributed devices 8 periodically lose contact with the master device 12. It will be appreciated that in some embodiments, the cluster 150 may be selected such that many, most or all of the distributed devices 8 loose contact with the master device. In other embodiments, the cluster 150 may be selected such that contact between the distributed devices 8 and the master device 12 is lost at predictable, probable or possible times recurring frequently or in response to some known event. In other embodiments, the cluster may be selected such that the contact between the distributed devices 8 and the master devices is interrupted in response to an unknown but predictable event. Furthermore, the cluster 150 is selected such that one or more of the distributed devices 8 of the cluster 150 or a nearby distributed devices 8 experience somewhat better or consistently better or consistent contact with the master device. It will be appreciated that the distributed device 8 experiencing such better communication will be designated as the distributed network host 152.

Identifying method 160 begins with the master device 12 reading a QOSR list with high values at step 162. High QOSR values indicate devices which are frequently identified as not being in communication with the master device 12. The master device 12 then selects a sub-set of distributed devices 8 with the highest QOSR values between those distributed devices 8 and the master device 12 in step 164.

The master device 12 then selects distributed devices 8 within the sub-set with low QOSR values to remaining distributed devices indicating good communication with the other distributed devices 8 of the sub-set in step 166. The master device 12 then selects the distributed devices identified in both of steps 164 and 166 in step 168. The master device 12 then records this sub-set as a cluster 150 in step 170 and repeats the identifying method 160 for all ungrouped devices having high QOSR values.

It will be appreciated that distributed devices 8 should be grouped where the devices in the cluster 150 have good quality of service factors between the members of the cluster and/or the nearby device but not directly to the master device 12 It will further be appreciated that it is preferable that one of the distributed devices 8 of the cluster 150 has some or good contact with the master device 12.

The selection of the cluster 150 may be based on QOS factors described above by way of non-limiting example. For example, a cluster 150 may be selected with low QOSR values between the devices (meaning that between all members of the cluster experience consistent communication with each other) for the time period in question but high QOSR values to the master device (meaning these devices have relative poor communication to the master device 12. Such a selection would be expected to produce a cluster 150 having long term internal stability. Clusters may be made larger or smaller with further selecting where QOSS and/or QOSA and/or combined QOSS & QOSA.

Turning now to FIG. 12, a method for identifying, selecting and assigning a distributed network host 152 to service a cluster 152 and is indicated generally at 180 and referred to herein as the host method 180. The host method begins at step 182 with the master device 12 reading a list of clusters 152 identifying each of the clusters 152 created in the identifying method 160 including the list distributed devices of each cluster 152. The master device 12 then selects a distributed device 8 for each cluster having the lowest QOSR value to the master device 12 indicating the most reliable communication with the master device 12 in step 184. This distributed device 8 is then designated as the distributed network host 152 for that cluster 150 in step 186. The master device 12 then assigns a separate distributed network host 152 for each time block 116 or sub-time block 118. It will be appreciated that the distributed network host 152 may the same distributed device for all, some or none of the time blocks 116 or sub-time blocks 118.

It will be appreciated that the distributed device 8 is identified which has low QOSR to a cluster 150 which have a relatively high QOSR for the time period in question. Further selection can be based on QOSS and/or QOSA and/or combinations of QOSS & QOSA to limit or increase the identifiable distributed network host 152 devices able to serve the cluster 150.

Turning now to FIG. 13, a method of transferring control to a distributed network host 152 is shown generally at 190 and is referred to herein as the transfer method 190. It will be appreciated that each distributed device 8 may be instructed by the master device 12 to act as a distributed network host 150 and to provide some of the functions and operations normally provided by the master device 12. However, the master device 12 will determine which distributed device will act as a distributed network host and what functions the distributed network host will provide and to what local group of distributed devices 8. It will also be appreciated that the distributed network host may be dedicated to the distributed network host function or may also engage in other application specific functions equivalent to other distributed devices 8. In the event of catastrophic failure by the master device 8, the first available distributed network host may assume emergency control of the communications network and indicate a trouble condition to report the master failure.

The transfer method 190 comprises the master device 12 recognizing that a known event will occur in the next time block 116 or sub-time block 118 in step 192. In step 194, the master device 12 then reads the cluster list of clusters 150 developed previously. The master device 12 then notifies each of the distributed network hosts 152 for each of the clusters 150 of the transfer of some or all of the functions of the master in step 196 and repeats this process for each cluster 150 in step 198. After all of the distributed network hosts 152 have been notified, the master device 12 transfers control or functions to them in step 200.

By way of non-limiting example every Monday morning 16 devices (referenced herein as D0 through D15) in a network 10 lose contact with the master device 12 for one hour. A nearby device (referenced herein as D16) experiences the same event which is of unknown origin unknown but predictable. However the nearby device has periodic contact with the master device 12 every six minutes approximately but normal contact is approximately every 2 minutes. When the time block 116 arrives that contains the unknown but predictable event, but before it occurs the master device 12 requests that the nearby device D16 function as a distributed network host 152 until the end of the time block 116 which is for a time period of approximately 3 hours. Device D16 informs devices D0 through D15 that host services will now be provided by it self (D16).

It will be appreciated that the master device 12 may also transfer control to a distributed network host 152 in response to a trigger condition. Examples of such trigger conditions may include, but are not limited to a group of distributed devices 8 losing contact repeatedly in short period of time, a group of distributed devices losing contact repeatedly over a long period of time, the master device 12 requests a distributed device to be a distributed network host 152 for a specific reason (e.g. service & maintenance to the master device), the master device 12 issues a panic condition or the master device 12 is unable to be contacted by a group of distributed devices 8. It will also be appreciated that the master device 12 may set a return time or may request the return later.

It will be appreciated by those of skill that the above methods for maintaining contact throughout a network utilize exemplary rules which may be modified by without limitation. Therefore different rules may be applied to the selection processes above. Non-limiting examples of such rules may include selecting the QOSR, QOSS and QOSA in groups to exceed the QOSR, QOSS and QOSA to the master device 12 by predetermined value to indication separation of network segments. The master device 12 may also select clusters 150 based on loss of contact duration as determined by a value indicating the length of time the cluster is out of contact or an ‘OutTimeValue’. The master device 12 may also select a time period 116 to transfer a cluster 150 to distributed network host 152 where transfer starts in a sub-time block 118 before the known, probable or predicted event occurs and lasts until after the sub-time block 118 in which the event concludes or probably concludes. Additionally, the return transfer of controls may be further validated by determining QOS values returning to normal, near normal or acceptable levels and/or the master device 12 requesting and/or accepting return of control.

While specific embodiments of the invention have been described and illustrated, such embodiments should be considered illustrative of the invention only and not as limiting the invention as construed in accordance with the accompanying claims.

What is claimed is:

1. A method of controlling communication between a plurality of devices having a plurality of routing paths between said plurality of devices, the method comprising;
measuring quality of communication between each of said plurality of devices;
recording communication values representing said quality of communication with an associated repeating time value;
selecting a current time value corresponding to a desired time period according to a selection criteria; and
selecting a routing path having an optimized communication value corresponding to said current time value.

2. The method of claim 1 wherein said selection criteria comprises combining successive communication values corresponding to the same repeating time value.

3. The method of claim 2 wherein said combining comprises utilizing a simplified smoothing function.

4. The method of claim 1 wherein said communication values are recorded intermittently.

5. The method of claim 1 wherein said communication values are recorded continuously.

6. The method of claim 1 wherein said communication values are recorded in a designated distributed device.

7. The method of claim 6 further comprising requesting said communication values from said designated distributed device.

8. The method of claim 1 wherein said repeating time values comprise a plurality of cyclical time segments ordered in a continuous repeating loop.

9. The method of claim 8 wherein said repeating time value repeats once every day.

10. The method of claim 8 wherein said repeating time value repeats once every week.

11. The method of claim 1 wherein said measuring communication comprises measuring a communication signal between a first device and each of said plurality of devices and wherein said communication values are recorded by said first device.

12. The method of claim 11 wherein said communication values are determined by utilizing a plurality of quality of service indicators.

13. The method of claim 12 wherein said quality of service indicators are selected from the group consisting of quality of service amplitude, quality of service signal quality and quality of service reported.

14. The method of claim 13 wherein said selecting a routing path comprises:
selecting at least one alternate route; and
selecting a best route of said at least one alternate routes having a highest combined quality of service amplitude indicator and quality of service signal quality indicator.

15. The method of claim 14 wherein said at least one alternate routes are selected to have the highest quality of service reported indicator from all of said routing paths.

16. The method of claim 14 wherein three of said at least one alternate routes are selected.

17. The method of claim 14 wherein, for each of said at least one alternate routes, said quality of service amplitude indictor and said quality of service signal quality indicator are combined into a single value.

18. The method of claim 14 wherein said quality of service amplitude is determined by comparing said communication signal amplitude to a known amplitude condition.

19. The method of claim 18 wherein said known amplitude condition comprises a theoretical ideal amplitude.

20. The method of claim 18 wherein said known amplitude condition comprises a previous best recorded amplitude.

21. The method of claim 14 wherein said quality of service signal quality is determined by comparing said communication signal to a known signal quality condition.

22. The method of claim 21 wherein said known signal quality condition comprises a theoretical ideal signal quality.

23. The method of claim 14 wherein said known signal quality condition comprises a previously best recorded signal quality.

24. The method of claim 14 wherein said quality of service reported comprise recording a reported list representing a rate of occurrence of communication between said plurality of devices.

25. The method of claim 14 wherein said reported list represents a rate of occurrence at which each of said plurality of devices is not in communication with said first device.

26. The method of claim 13 wherein said plurality of devices form a part of a network having a master device and a plurality of slave devices, the method further comprising using said communication values to distribute functions from said master device to a designated slave device.

27. The method of claim 26 wherein said functions are distributed from said master device to said designated slave device in response to a triggering event.

28. The method of claim 27 wherein said triggering event is a predetermined time occurrence.

29. The method of claim 26 wherein said designated slave device is selected prior to said triggering event.

30. The method of claim 26 wherein said designated slave device is selected by weighting said quality of service amplitude, said quality of service signal quality and said quality of service reported.

31. The method of claim 30 wherein said quality of service reported is assigned a greater weight than said quality of service amplitude and said quality of service signal quality.

32. The method of claim 30 wherein said quality of service amplitude and said quality of service signal quality are assigned a greater weight than said quality of service reported.

33. The method of claim 30 further comprising utilizing said communication values to record an ordered list of said designated slave devices for each corresponding repeating time value.
